(19) United States
(12) Patent Application Publication
(10) Pub. No.: US 2011/0194513 A1
(43) Pub. Date: Aug. 11, 2011

(54) METHOD FOR CONTROLLING TRANSMITTING POWER OF CONTROL CHANNEL OF CSG PICO BASE STATION

(75) Inventor: Dong Hee KIM, Jeonju (KR)

(73) Assignee: Electronics and Telecommunications Research Institute, Daejeon (KR)

(21) Appl. No.: 13/024,746

(22) Filed: Feb. 10, 2011

(30) Foreign Application Priority Data
Feb. 10, 2010 (KR) 10-2010-0012184
Feb. 10, 2011 (KR) 10-2011-0011769

(51) Int. Cl. H04W 52/04; H04W 72/04; H04W 36/00

(52) U.S. Cl. 370/329; 455/522; 455/444

(57) ABSTRACT

Provided is a method of controlling a transmit power of a control channel transmitted from a pico base station. The pico base station may control the transmit power of the control channel based on a position of a macro terminal adjacent to the pico base station. When the macro terminal is positioned within a coverage of the pico base station, the pico base station enables the macro terminal to receive a control signal without interference from the macro base station by decreasing the transmit power of the control channel.

### CROSS-REFERENCE TO RELATED APPLICATION

This application claims the benefit of Korean Patent Application Nos. 10-2010-0012184 and 10-2011-0011769, filed on Feb. 10, 2010 and Feb. 10, 2011, respectively, in the Korean Intellectual Property Office, the disclosure of which is incorporated herein by reference.

### BACKGROUND

1. Field of the Invention

The present invention relates to a method of controlling a control channel power of a pico base station, and more particularly, to a method of controlling a control channel power of a pico base station based on a position of a macro terminal.

2. Description of the Related Art

A network in which a macro base station and a pico base station use the same frequency resource is referred to as a heterogeneous network. In this network, interference may exist between a macro cell including the macro base station and a pico cell including the pico base station.

Interference in a data channel may be controllable using interference avoidance technology, for example, inter-cell interference cancelling (ICIC) technology. However, it may be very difficult to control interference in a control channel transmitted using the same frequency and the same time interval.

In the case of a pico base station accessible by all the terminals, for example, an open subscriber group (OSG) pico base station, when a macro terminal connected to a macro base station approaches the pico base station, the pico base station may allow handover of the macro terminal. Accordingly, an interference issue of the control channel may be insignificant.

However, in the case of a pico base station accessible by only a predetermined terminal, for example, a closed subscriber group (CSG) pico base station, even though a macro terminal connected to a macro base station approaches the pico base station, the pico base station may not allow handover of the macro terminal.

Accordingly, the macro terminal may need to transmit data to the macro base station even within a coverage of the pico base station. Since the macro terminal may receive a significantly strong interference signal from the pico base station within the coverage of the pico base station, the communication quality may be deteriorated.

### SUMMARY

An aspect of the present invention provides a method that enables a macro terminal to maintain a connection with a macro base station even around a pico base station.

Another aspect of the present invention also provides a method and apparatus that may decrease the effect of interference around a pico base station.

According to an aspect of the present invention, there is provided a method of controlling a power of a pico base station, the method including: determining whether a macro terminal connected to a macro base station is positioned within a coverage of the pico base station; and controlling a transmit power of a control channel transmitted using at least one frequency band, depending on the determination result.

According to another aspect of the present invention, there is provided an operation method of a macro terminal, including: generating signal quality information of a reference signal received from a pico base station; transmitting the signal quality information to a macro base station; and receiving an interference signal with a decreased strength with respect to at least one frequency band among a plurality of frequency bands assigned to the pico base station, when the signal quality information is used to determine whether the macro terminal is positioned within a coverage of the pico base station, and when the macro terminal is positioned within the coverage of the pico base station.

According to still another aspect of the present invention, there is provided an operation method of a macro base station, including: receiving, from a macro terminal, a signal quality of a reference signal received by the macro terminal from a pico base station; and determining whether the macro terminal is positioned within a coverage of the pico base station based on the signal quality of the reference signal. The macro terminal may receive, from the pico base station, an interference signal with a decreased strength with respect to at least one frequency band among a plurality of frequency bands assigned to the pico base station, depending on the determination result.

According to embodiments of the present invention, a macro terminal may maintain a connection with a macro base station even around a pico base station.

Also, according to embodiments of the present invention, it is possible to decrease the effect of interference around a pico base station.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram to describe an operation of a macro base station and a pico base station according to an embodiment of the present invention;

FIG. 2 is a diagram to describe a method of controlling a control channel power according to an embodiment of the present invention;

FIG. 3 is a diagram to describe a method of controlling a control channel power according to another embodiment of the present invention;

FIG. 4 is a flowchart illustrating an operation method of a pico base station according to an embodiment of the present invention;

FIGS. 5A and 5B are flowcharts illustrating an operation of determining whether a macro terminal is positioned within a coverage of a pico base station of FIG. 4;

FIG. 6 is a flowchart illustrating an operation method of a macro terminal according to an embodiment of the present invention;

FIG. 7 is a flowchart illustrating an operation of generating a signal quality of a reference signal of FIG. 6; and

FIG. 8 is a flowchart illustrating an operation method of a macro base station according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

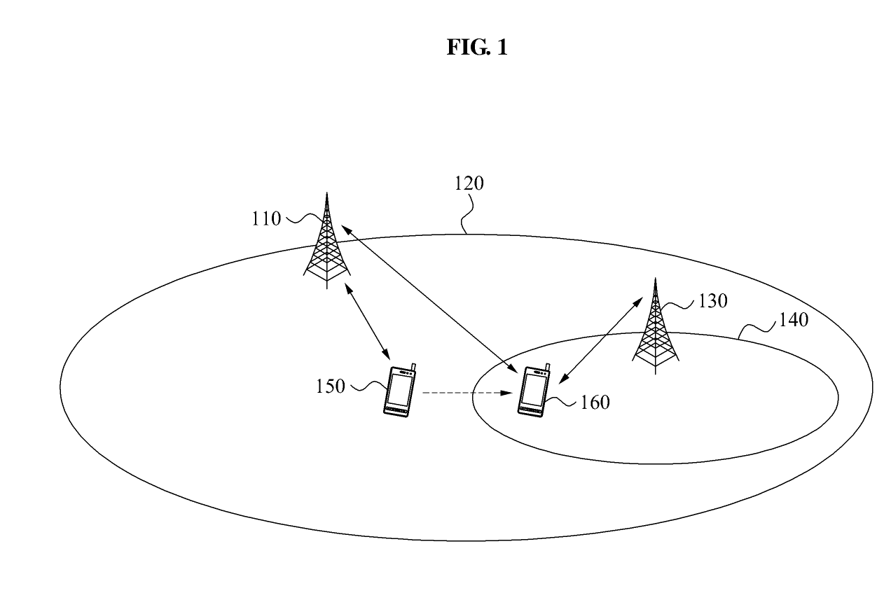

FIG. 1 is a diagram to describe an operation of a macro base station 110 and a pico base station 130 according to an embodiment of the present invention.

Here, the pico base station 130 corresponds to a base station that may transmit data using a portion of or all of frequency bands assigned to the macro base station 110 within a coverage 120 of the macro base station 110. A coverage 140 of the pico base station 130 may be included in the coverage 120 of the macro base station 110.

The macro base station 110 and the pico base station 130 may use the same frequency band. For ease of description, it is assumed that the macro base station 110 and the pico base station 130 use the same frequency bands f1 and f2. The macro base station 110 and the pico base station 130 may transmit a control channel using all of the frequency bands f1 and f2. Here, a primary frequency band of the macro base station 110 may be f1 and a secondary frequency band of the macro base station 110 may be f2. The macro base station 110 and a macro terminal 150 may transmit data using f1 or f2. In this case, a primary frequency band of the pico base station 130 may be f2 and a secondary frequency band of the pico base station 130 may be f1. Using f1 or f2, the pico base station 130 may transmit data to a pico terminal connected to the pico base station 130.

According to an aspect, the macro base station 110 may assign, with respect to a control channel transmitted using the secondary frequency band, a relatively low power compared to a power of a control channel transmitted using the primary frequency band.

According to another aspect, the pico base station 130 may not transmit any control channel by assigning a transmit power of ‘0’ with respect to the control channel transmitted using the secondary frequency band.

In this case, the macro terminal 150 connected to the macro base station 110 may receive the control channel from the macro base station 110 using f1 that is the primary frequency band of the macro base station 110. Also, the pico base station 130 may not transmit any control channel with respect to f1 that is the secondary frequency band of the pico base station 130.

Even through the macro terminal 150 is positioned within the coverage 140 of the pico base station 130 (here, the macro terminal 150 corresponds to a macro terminal 160), the macro terminal 160 may not receive an interference signal from the pico base station 130 using only the frequency band f1. Accordingly, the macro terminal 160 may communicate with the macro base station 110 without interference of the control channel.

The pico base station 130 may transmit the control channel by employing both the primary frequency band f2 of the pico base station 130 and the secondary frequency band f1 of the pico base station 130. When the macro terminal 160 is determined to be positioned within the coverage 140 of the pico base station 130, the pico base station 130 may transmit the control channel using only the primary frequency band f2 of the pico base station 130 and may not transmit the control channel using the secondary frequency band f1 of the pico base station 130.

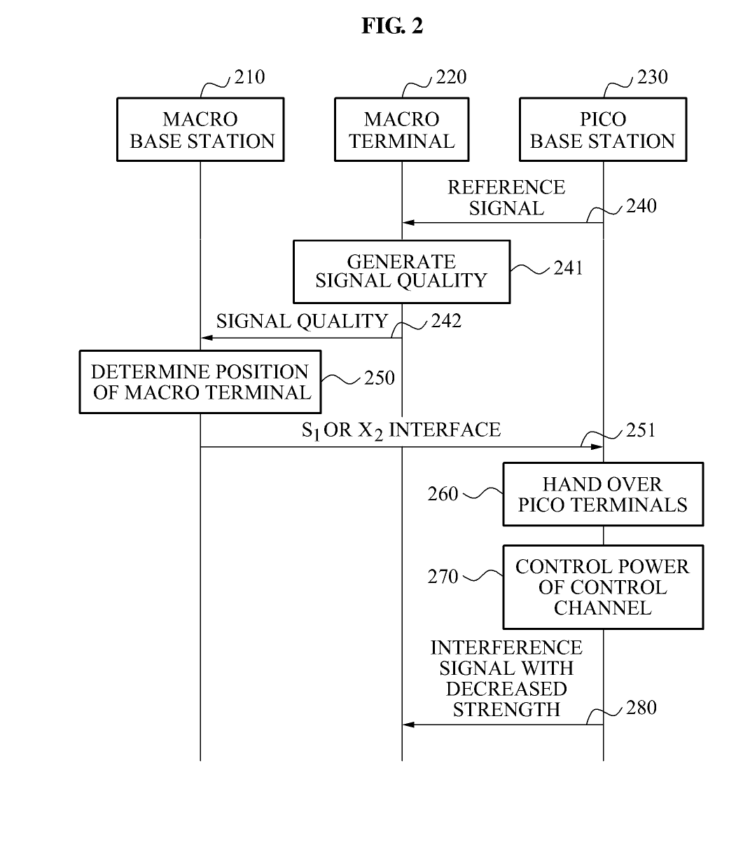

FIG. 2 is a diagram to describe a method of controlling a control channel power according to an embodiment of the present invention.

In operation 240, a pico base station 230 may transmit a reference signal to a macro terminal 220. A pilot signal of which a pattern is known to the macro terminal 220 may be used for the reference signal.

In operation 241, the macro terminal 220 may generate a signal quality with respect to the received reference signal. The macro terminal 220 may generate a reference signal received power (RSRP) or a signal to noise ratio (SNR) of the reference signal as the signal quality.

In operation 242, the macro terminal 220 may transmit the signal quality to a macro base station 210.

In operation 250, the macro base station 210 may determine whether the macro terminal 220 is positioned within a coverage of the pico base station 230. The macro base station 210 may determine whether the macro terminal 220 is positioned within the coverage of the pico base station 230 based on the signal quality received from the macro terminal 220.

The macro base station 210 may compare the signal quality with a predetermined threshold. When the macro terminal 220 is positioned within the coverage of the pico base station 230, the macro terminal 220 may receive a strong interference signal from the pico base station 230. In this case, a strength of the reference signal received by the macro terminal 22 from the pico base station 230 may be greater than the predetermined threshold. An SNR of the reference signal received by the macro terminal 220 from the pico base station 230 may be greater than the predetermined threshold.

When the signal quality received from the macro terminal 220 is greater than the predetermined threshold, the macro base station 210 may determine that the macro terminal 220 is positioned within the coverage of the pico base station 230, and may generate information regarding whether the macro terminal 220 is positioned within the coverage of the pico base station 230.

In operation 251, the macro base station 210 may transmit, to the pico base station 230, information regarding whether the macro terminal 220 is positioned within the coverage of the pico base station 230. The macro base station 210 and the pico base station 230 may be connected to each other using an S1 interface or an X2 interface. In this case, the macro base station 210 may transmit, to the pico base station 230 using the S1 interface or the X2 interface, information regarding whether the macro terminal 220 is positioned within the coverage of the pico base station 230. The pico base station 230 may determine that the macro terminal 220 is positioned within the coverage of the pico base station 230 based on information regarding whether the macro terminal 220 is positioned within the coverage of the pico base station 230.

In operation 260, the pico base station 230 may control pico terminals connected to the pico base station 230 using a secondary frequency band f1 of the pico base station 230 to hand over to a primary frequency band f2 of the pico base station 230. When the handover is completed, all the pico terminals connected to the pico base station 230 may be connected to the pico base station 230 using the primary frequency band f2 of the pico base station 230.

In operation 270, the pico base station 230 may decrease a transmit power with respect to the secondary frequency band f1 of the pico base station 230. The pico base station 230 may control a transmit power of a control channel to be ‘0’ so that any control channel may not be transmitted.

In operation 280, the macro terminal 220 may receive the control channel from the macro base station 210 using a primary frequency band f1 of the macro base station 210. Also, since a strength of the control channel transmitted from the pico base station 230 using f1 is significantly small or ‘0’, the macro terminal 220 may receive the control channel with the decreased strength from the pico base station 230. Specifically, a strength of an interference signal received from the pico base station 230 may decrease.

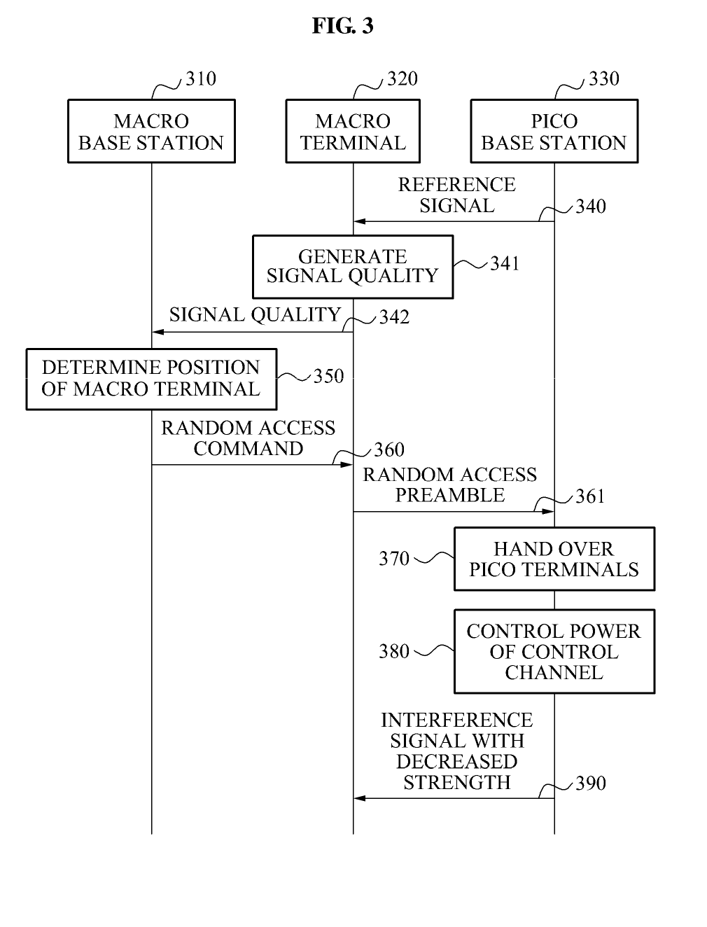

FIG. 3 is a diagram to describe a method of controlling a control channel power according to another embodiment of the present invention.

Operations 340 through 350 are similar to operations 240 through 250 of FIG. 2 and thus, further detailed description related thereto will be omitted here.

When a macro terminal 320 is determined to be positioned within a coverage of a pico base station 330 in operation 350, a macro base station 310 may transmit a random access command to the macro terminal 320 in operation 360.

In operation 361, the macro terminal 320 may transmit a random access preamble to the pico base station 330. The random access command may include information associated with the random access preamble to be transmitted by the macro terminal 320. The random access preamble transmitted by the macro terminal 320 may be a random access preamble assigned with respect to macro terminals positioned within the coverage of the pico base station 330 among random access preambles assigned to the macro base station 310. In this case, the pico base station 330 may determine that the macro terminal 320 is positioned within the coverage of the pico base station 330 based on the random access preamble received from the macro terminal 320.

Hereinafter, operations 370 through 390 are similar to operations 260 through 280 of FIG. 2 and thus, further detailed description will be omitted here.

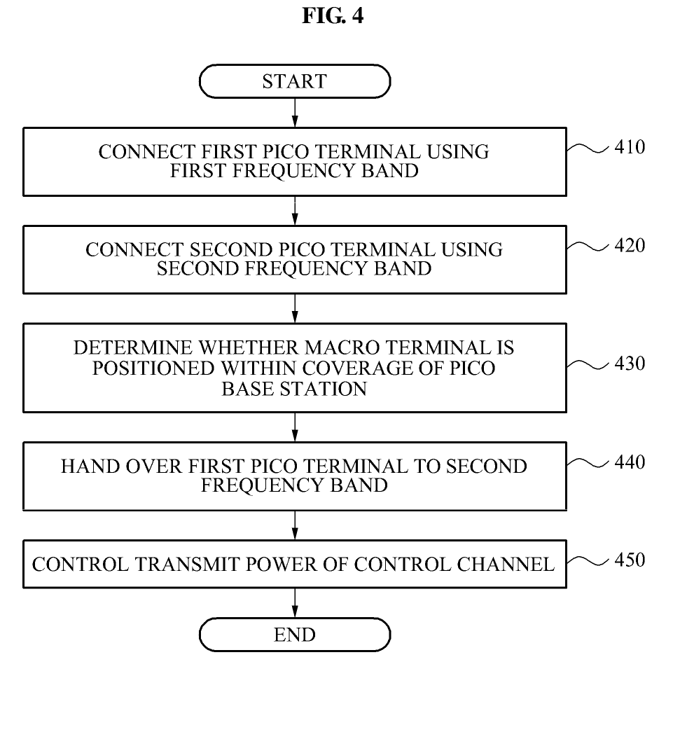

FIG. 4 is a flowchart illustrating an operation method of a pico base station according to an embodiment of the present invention.

In operation 410, the pico base station may be connected with a first pico terminal using a first frequency band. Here, the first frequency band may be a secondary frequency band of the pico base station. The first frequency band may be a primary frequency band of a macro base station. A macro terminal and the macro base station may be connected to each other using the first frequency band.

In operation 420, the pico base station may be connected with a second pico terminal using a second frequency band. Here, the second frequency band may be a primary frequency band of the pico base station.

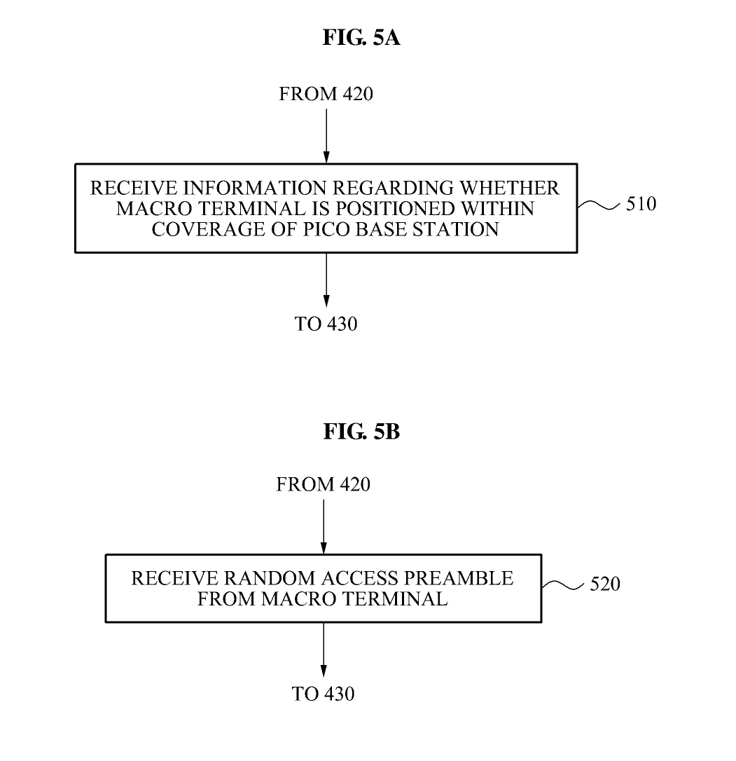

In operation 430, the pico base station may determine whether the macro terminal is positioned within a coverage of the pico base station. An operation of determining whether the macro terminal is positioned within the coverage of the pico base station will be further described with reference to FIG. 5.

In operation 440, the pico base station may hand over, to the second frequency band, the first pico terminal connected using the first frequency band. When the first pico terminal is handed over to the second frequency band, the pico base station may have no need to transmit a control signal using the first frequency band.

In operation 450, the pico base station may decrease a transmit power of the control signal transmitted using the first frequency band. The pico base station may control a transmit power of the control signal transmitted using the first frequency band to be ‘0’.

In operation 450, the macro terminal may be connected to the macro base station using the first frequency band that is the primary frequency band of the macro base station. Since the pico base station may transmit a control signal with a weak strength or may not transmit the control signal using the first frequency band, the macro terminal may receive the control signal from the macro base station without receiving the effect of an interference signal.

Also, in operation 450, the pico base station may transmit the control signal to the first pico terminal and the second pico terminal using the second frequency band that is the primary frequency band of the pico base station.

FIGS. 5A and 5B are flowcharts illustrating an operation of determining whether the macro terminal is positioned within the coverage of the pico base station of FIG. 4.

FIG. 5A is a flowchart to describe an operation of determining a position of the macro terminal based on information directly received by the pico base station from the macro base station. The macro base station may generate information associated with the position of the macro terminal based on a signal quality received from the macro terminal. The macro base station and the pico base station may be directly connected to each other using an S1 interface or an X2 interface. In operation 510, the pico base station may directly receive information associated with the position of the macro terminal from the macro base station, and may determine whether the macro terminal is positioned within the coverage of the pico base station based on information associated with the position of the macro terminal.

FIG. 5B is a flowchart to describe an operation of determining the position of the macro terminal based on the random access preamble received by the pico base station from the macro terminal. The macro base station may determine the position of the macro terminal based on the signal quality received from the macro terminal.

When the macro terminal is determined to be positioned within the coverage of the pico base station, the macro base station may transmit, to the macro terminal, a random access command with respect to the pico base station.

According to the random access command, the macro terminal may transmit a random access preamble to the pico base station. When the pico base station receives the random access preamble from the macro terminal in operation 520, the pico base station may determine that the macro terminal is positioned within the coverage of the pico base station.

The random access preamble transmitted by the macro terminal may be a preamble assigned with respect to the macro terminal among random access preambles that the pico base station may receive. Accordingly, when the pico base station receives the preamble assigned to the macro terminal, the pico base station may determine that the macro terminal is positioned within the coverage of the pico base station.

The macro base station may transmit a random access command to the macro terminal using a handover instruction message, a layer 1/layer 2 (L1/L2) indicator, and the like.

The random access command may include information associated with the random access preamble to be transmitted by the macro terminal. The macro terminal may transmit the random access preamble based on information associated with the random access preamble included in the random access command.

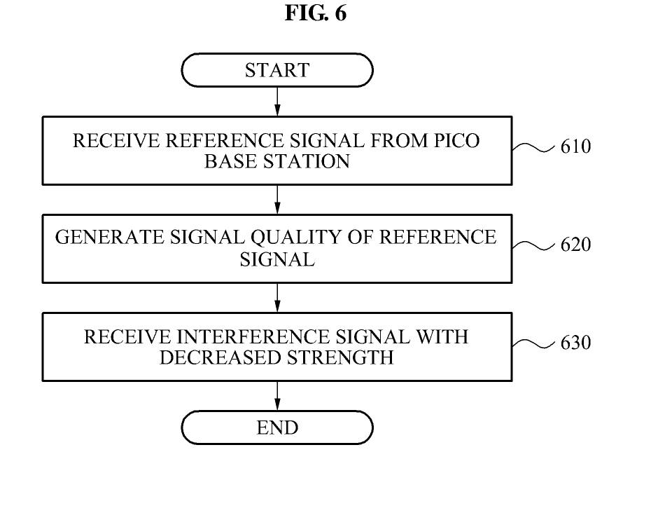

FIG. 6 is a flowchart illustrating an operation method of a macro terminal according to an embodiment of the present invention.

In operation 610, the macro terminal may receive a reference signal from a pico base station. A pilot signal of which a pattern is known to the macro terminal may be used for the reference signal.

In operation 620, the macro terminal may generate a signal quality of the reference signal. An RSRP or an SNR of the reference signal may be generated as signal quality information.

Also, in operation 620, the macro terminal may transmit the generated signal quality of the reference signal to a macro base station. The macro base station may determine whether the macro terminal is positioned within a coverage of the pico base station based on the signal quality of the reference signal, and may generate information associated with a position of the macro terminal.

The macro base station and the pico base station may be directly connected to each other using an S1 interface or an X2 interface. The macro base station may directly transmit information associated with the position of the macro terminal to the pico base station.

In operation 630, the pico base station may control a transmit power of a control channel based on information associated with the position of the macro terminal. The pico base station may decrease the transmit power of the control channel, or may control the transmit power of the control channel to be ‘0’.

The control channel received by the macro terminal from the pico base station may correspond to an interference signal. Accordingly, the macro terminal may receive the interference signal with a decreased strength from the pico base station in operation 630.

The pico base station may transmit the control channel using a plurality of frequency bands. In this case, the pico base station may select at least one frequency band from the plurality of frequency bands, and may control the transmit power of the control channel transmitted using the selected at least one frequency band. The pico base station may select a frequency band via which the macro terminal and the macro base station are connected to each other, and thereby control the transmit power of the control channel.

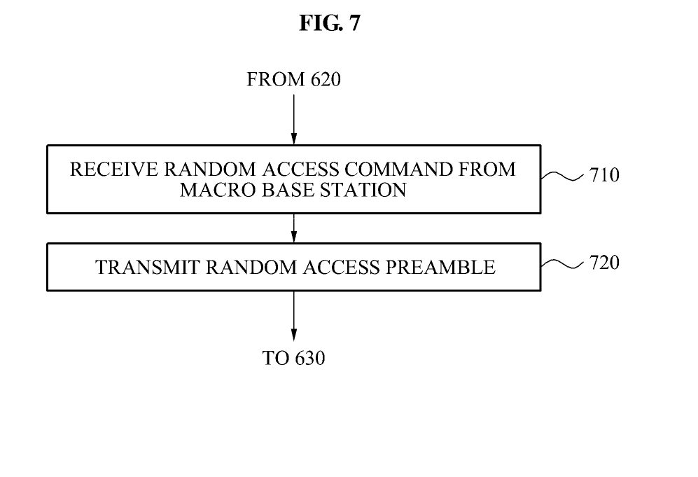

FIG. 7 is a flowchart illustrating an operation of generating a signal quality of a reference signal of FIG. 6.

The macro base station and the pico base station may not be directly connected to each other using the S1 interface or the X2 interface.

In this case, the macro base station may determine whether the macro terminal is positioned within the coverage of the pico base station based on the signal quality of the reference signal, and may transmit, to the macro terminal, a random access command with respect to the pico base station.

In operation 710, the macro terminal may receive the random access command with respect to the pico base station.

In operation 720, the macro terminal may transmit a random access preamble to the pico base station according to the random access command. The pico base station may determine the position of the macro terminal based on the random access preamble.

The pico base station may determine that the macro terminal is positioned within the coverage of the pico base station based on the random access preamble, and may decrease a power of the control channel to be transmitted to the macro terminal.

In operation 630, the macro terminal may receive an interference signal with the decreased strength from the pico base station.

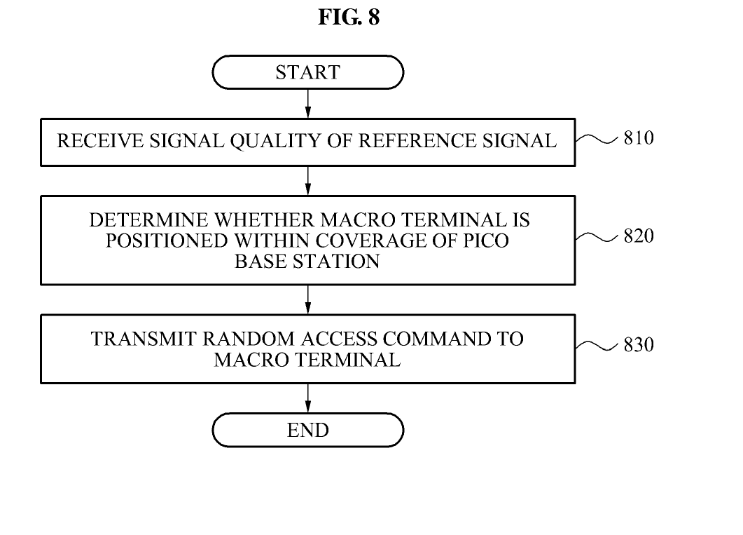

FIG. 8 is a flowchart illustrating an operation method of a macro base station according to an embodiment of the present invention.

In operation 810, a macro terminal may generate a signal quality of a reference signal received from a pico base station. The macro base station may receive the generated signal quality from the macro terminal.

The macro base station may receive an RSRP or an SNR of the reference signal as the signal quality.

In operation 820, the macro base station may determine whether the macro terminal is positioned within a coverage of the pico base station. The macro base station may compare the received signal quality with a threshold and thereby determine a position of the macro terminal.

The signal quality may be an RSRP. In this case, the macro base station may compare a first threshold with the RSRP. When the RSRP is greater than the first threshold, the macro base station may determine that the macro terminal is positioned within the coverage of the pico base station.

The signal quality may be an SNR of the reference signal received by the macro terminal from the pico base station. In this case, the macro base station may compare a second threshold with the SNR of the reference signal. When the SNR of the reference signal is greater than the second threshold, the macro base station may determine that the macro terminal is positioned within the coverage of the pico base station.

The macro base station and the pico base station may be directly connected to each other using an S1 interface or an X2 interface. When the macro terminal is determined to be positioned within the coverage of the pico base station, the macro base station may directly transmit information associated with the position of the macro terminal to the pico base station.

When the macro terminal is determined to be positioned within the coverage of the pico base station, the macro base station may transmit, to the macro terminal, a random access command with respect to the pico base station in operation 830. The macro terminal may transmit a random access preamble to the pico base station according to the random access command. The pico base station may determine that the macro terminal is positioned within the coverage of the pico base station based on the random access preamble.

When the pico base station recognizes the position of the macro terminal, the pico base station may control a power of a control channel to be transmitted to the macro terminal. The pico base station may transmit the control channel using a plurality of frequency bands. In this case, the pico base station may control a transmit power of the control channel transmitted using the frequency band via which the macro terminal and the macro base station are connected to each other. The pico base station may minimize a strength of an interference signal to be transmitted to the macro terminal by controlling the transmit power of the control channel to be ‘0’.

The pico base station may be connected to pico terminals using a plurality of frequency bands. In this case, the pico base station may determine, from the plurality of frequency bands, a frequency band via which the macro terminal and the macro base station are connected to each other. The pico base station may instruct the connected pico terminals using the frequency band to hand over to another frequency band. When the pico terminals are handed over, the pico base station may not transmit a control signal using a corresponding frequency band. Accordingly, the pico base station may decrease a transmit power of the control channel transmitted using the corresponding frequency band, or may control the transmit power of the control channel to be ‘0’.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of controlling a power of a pico base station, the method comprising:
determining whether a macro terminal connected to a macro base station is positioned within a coverage of the pico base station; and
controlling a transmit power of a control channel transmitted using at least one frequency band, depending on the determination result.

2. The method of claim 1, further comprising:
receiving, from the macro base station, information regarding whether the macro terminal is positioned within the coverage of the pico base station,
wherein the determining comprises determining whether the macro terminal is positioned within the coverage of the pico base station based on the received information.

3. The method of claim 2, wherein information regarding whether the macro terminal is positioned within the coverage of the pico base station is generated based on a signal quality of a reference signal received by the macro terminal from the pico base station.

4. The method of claim 3, wherein the signal quality of the reference signal is a reference signal received power (RSRP) or a signal to noise ratio (SNR) of the reference signal.

5. The method of claim 1, wherein the determining comprises determining whether the macro terminal is positioned within the coverage of the pico base station when a random access preamble is received from the macro terminal.

6. The method of claim 5, wherein the macro terminal receives, from the macro base station, a random access command that is generated based on a signal quality of a reference signal received by the macro terminal from the pico base station, and transmits the random access preamble according to the random access command.

7. The method of claim 5, wherein the random access preamble is assigned with respect to the macro terminal.

8. The method of claim 1, further comprising:
connecting the pico base station and a first pico terminal using a first frequency band and connecting the pico base station and a second pico terminal using a second frequency band; and
handing over, to the second frequency band depending on the determination result, the first pico terminal connected using the first frequency band,
wherein the controlling comprises decreasing the transmit power of the control channel transmitted using the first frequency band.

9. An operation method of a macro terminal, comprising:
generating signal quality information of a reference signal received from a pico base station;
transmitting the signal quality information to a macro base station; and
receiving an interference signal with a decreased strength with respect to at least one frequency band among a plurality of frequency bands assigned to the pico base station, when the signal quality information is used to determine whether the macro terminal is positioned within a coverage of the pico base station, and when the macro terminal is positioned within the coverage of the pico base station.

10. The method of claim 9, wherein the signal quality of the reference signal is a reference signal received power (RSRP) or a signal to noise ratio (SNR) of the reference signal.

11. The method of claim 9, further comprising:
receiving a random access command from the macro base station when the macro terminal is positioned within the coverage of the pico base station; and
transmitting a random access preamble to the pico base station according to the random access command,
wherein the receiving of the interference signal comprises receiving the interference signal based on the random access preamble.

12. The method of claim 9, wherein when the macro terminal is positioned within the coverage of the pico base station, the pico base station receives, from the macro base station, information associated with a position of the macro terminal and decreases a strength of the interference signal based on information associated with the position of the macro terminal.

13. An operation method of a macro base station, comprising:
receiving, from a macro terminal, a signal quality of a reference signal received by the macro terminal from a pico base station; and
determining whether the macro terminal is positioned within a coverage of the pico base station based on the signal quality of the reference signal,
wherein the macro terminal receives, from the pico base station, an interference signal with a decreased strength with respect to at least one frequency band among a plurality of frequency bands assigned to the pico base station, depending on the determination result.

14. The method of claim 13, wherein the signal quality of the reference signal is a reference signal received power (RSRP) or a signal to noise ratio (SNR) of the reference signal.

15. The method of claim 13, wherein the determining comprises determining that the macro terminal is positioned within the coverage of the pico base station when the signal quality of the reference signal is greater than a predetermined threshold.

16. The method of claim 13, further comprising:
transmitting the determination result to the pico base station when the macro terminal is positioned within the coverage of the pico base station.

17. The method of claim 13, further comprising:
transmitting, to the macro terminal, a random access command with respect to the pico base station when the macro terminal is positioned within the coverage of the pico base station,
wherein the pico base station decreases a strength of the interference signal based on a random access preamble transmitted from the macro terminal to the pico base station according to the random access command.
